(19) United States
(12) Patent Application Publication
(10) Pub. No.: US 2025/0070895 A1
(43) Pub. Date: Feb. 27, 2025

(54) CONTROL DEVICE, NON-TRANSITORY COMPUTER READABLE STORAGE MEDIUM, AND CONTROL SYSTEM

(71) Applicant: KABUSHIKI KAISHA TOKAI RIKA DENKI SEISAKUSHO, Aichi (JP)

(72) Inventors: Takuji TATSUYAMA, Aichi (JP); Tadayuki TOBIMATSU, Aichi (JP); Yosuke DOI, Aichi (JP)

(73) Assignee: KABUSHIKI KAISHA TOKAI RIKA DENKI SEISAKUSHO, Aichi (JP)

(21) Appl. No.: 18/795,377

(22) Filed: Aug. 6, 2024

(30) Foreign Application Priority Data
Aug. 24, 2023 (JP) 2023-136140

(51) Int. Cl. H04B 17/21; H04B 17/318

(52) U.S. Cl. CPC H04B 17/21; H04B 17/318

(57) ABSTRACT

There is provided a control device, comprising: a control unit that performs calibration processing for calibrating a radio wave intensity of a signal transmitted and received between a control target and a portable device on the basis of calibration information stored in the portable device, wherein whether or not to cause a controlled device provided in the control target to perform a prescribed operation is determined on the basis of the calibrated radio wave intensity.

### CROSS REFERENCE TO RELATED APPLICATION(S)

This application is based upon and claims benefit of priority from Japanese Patent Application No. 2023-136140, filed on Aug. 24, 2023, the entire contents of which are incorporated herein by reference.

### BACKGROUND

The present invention relates to a control device, a non-transitory computer readable storage medium, and a control system.

In recent years, there has been developed a technology of estimating a distance to a portable device on the basis of the received radio wave intensity of a signal received from the portable device. However, the output radio wave intensity of portable devices may differ depending on the model and the like. Therefore, Japanese Patent Application Laid-open No. 2019-32169 discloses a technology of improving estimation accuracy by leveling the received radio wave intensity of a signal received from a portable device on the basis of calibration information.

### SUMMARY

However, in the technology disclosed in Japanese Patent Application Laid-open No. 2019-32169, the calculation and storage of calibration information is performed by an electronic control unit (ECU) provided in a mobile body. For this reason, in the technology disclosed in Japanese Patent Application Laid-open No. 2019-32169, the increase in the number of portable devices (users) results in the increase of calibration information, which oppresses a memory of the ECU.

In view of the above-described problem, the present invention aims at improving the estimation accuracy while reducing the ECU memory usage.

To solve the above described problem, according to an aspect of the present invention, there is provided a control device, comprising: a control unit that performs calibration processing for calibrating a radio wave intensity of a signal transmitted and received between a control target and a portable device on the basis of calibration information stored in the portable device, wherein whether or not to cause a controlled device provided in the control target to perform a prescribed operation is determined on the basis of the calibrated radio wave intensity.

To solve the above described problem, according to another aspect of the present invention, there is provided a non-transitory computer readable storage medium storing a program, the program causing a computer to achieve: a control function of performing calibration processing for calibrating a radio wave intensity of a signal transmitted and received between a control target and a portable device on the basis of calibration information stored in the portable device, wherein whether or not to cause a controlled device provided in the control target to perform a prescribed operation is determined on the basis of the calibrated radio wave intensity.

To solve the above described problem, according to another aspect of the present invention, there is provided a control system, comprising: a program causing a computer to achieve a control function of performing calibration processing for calibrating a radio wave intensity of a signal transmitted and received between a control target and a portable device on the basis of calibration information stored in the portable device; and a determination device that determines whether or not to cause a controlled device provided in the control target to perform a prescribed operation on the basis of the calibrated radio wave intensity.

In the invention described above, it is possible to improve the estimation accuracy while reducing the ECU memory usage.

### BRIEF DESCRIPTION OF THE DRAWINGS

FIG. 1 is a block diagram illustrating a functional configuration example of a control system 1 according to an embodiment of the present invention;

FIG. 2 is a sequence diagram illustrating an example of a flow of calculation and storage of calibration information by the control system 1 according to the embodiment;

FIG. 3 is a sequence diagram illustrating an example of a flow of RSSI calibration by a control application 220 according to the embodiment;

FIG. 4 is a sequence diagram illustrating an example of a flow of RSSI calibration by a control device 120 according to the embodiment;

FIG. 5 is a sequence diagram illustrating a flow of calibration processing based on calibration information included in a measurement signal according to the embodiment; and

FIG. 6 is a sequence diagram illustrating a flow of calibration processing for controlling the output radio wave intensity of a signal on the basis of calibration information according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### <<1.1. Functional Configuration Example>>

First, a functional configuration example of the control system 1 according to an embodiment of the present invention will be described.

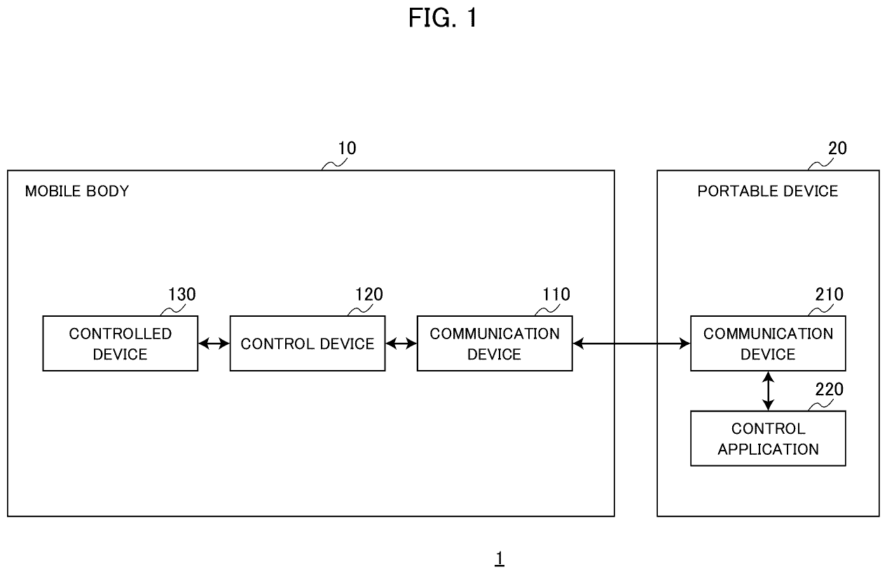

FIG. 1 is a block diagram illustrating a functional configuration example of the control system 1 according to an embodiment of the present invention.

As illustrated in FIG. 1, the control system 1 of the embodiment includes a mobile body 10 and a portable device 20.

As illustrated in FIG. 1, the mobile body 10 of the embodiment includes a communication device 110, a control device 120, and a controlled device 130.

Further, the portable device 20 of the embodiment includes a communication device 210, and a control application 220 is installed.

### (Mobile Body 10)

The mobile body 10 of the embodiment may be, for example, a vehicle, an airplane, a ship, or the like.

Note that the mobile body 10 of the embodiment is an example of a control target that transmits and receives signals to and from the portable device 20.

However, the control target of the present invention is not limited to the mobile body 10. The control target may be, for example, a building or the like including a controlled device 130 such as a door.

### (Communication Device 110)

The communication device 110 of the embodiment performs wireless communication conforming to a prescribed communication standard with the communication device 210 of the portable device 20.

The prescribed communication standard may be, for example, the Bluetooth (Registered Trademark) Low Energy (BLE).

However, the prescribed communication standard is not limited to the above-described example, and may be set arbitrarily.

### (Control Device 120)

The control device 120 of the embodiment controls the above-described wireless communication by the communication device 110.

Further, the control device 120 of the embodiment functions as a determination device for determining whether or not to cause the controlled device 130 to perform a prescribed operation on the basis of the received radio wave intensity (RSSI: received signal strength indicator) of a signal received by the communication device 110 from the communication device 210.

If the RSSI of the signal received by the communication device 110 from the communication device 210 exceeds a threshold value, for example, the control device 120 of the embodiment may determine that the portable device 20 is within a predetermined distance from the mobile body 10, and cause the controlled device 130 to perform a prescribed operation.

In addition to the determination based on RSSI as described above, the control device 120 may authenticate the portable device 20 on the basis of various kinds of information received by the communication device 110 from the communication device 210, and determine whether or not to perform a prescribed operation further on the basis of the authentication result.

In this case, if the RSSI exceeds the threshold value and the authenticity of the portable device 20 is recognized in the above-described authentication, the control device 120 causes the controlled device 130 to perform a prescribed operation

Further, as described later, the control device 120 of the embodiment may perform calibration processing for calibrating the radio wave intensity of signals transmitted and received between the mobile body 10 and the portable device 20 on the basis of the calibration information stored in the portable device 20.

The control device 120 of the embodiment is achieved by various ECUs.

### (Controlled Device 130)

The controlled device 130 of the embodiment may be various devices that perform prescribed operations in accordance with the control by the control device 120.

As illustrated in FIG. 1, in a case where the controlled device 130 is provided in the mobile body 10, the controlled device 130 may be, for example, a locking and unlocking device that locks and unlocks the door of the mobile body 10 as the above-described prescribed operation.

However, the controlled device 130 and the prescribed operation are not limited to the above-described example.

For example, the controlled device 130 may be an engine. In this case, the prescribed operation may be permission or restriction of engine start.

Further, for example, the controlled device 130 may be a lighting device. In this case, the prescribed operation may be turning on or off lighting.

### (Portable Device 20)

The portable device 20 of the embodiment is carried by a user of the mobile body 10 (the owner of the mobile body 10, or a person authorized to use the mobile body 10 by the owner, for example).

The portable device 20 of the embodiment may be, for example, a smartphone, a tablet, a wearable device, or the like.

### (Communication Device 210)

The communication device 210 of the embodiment performs wireless communication conforming to a prescribed communication standard with the communication device 110 provided in the mobile body 10.

### (Control Application 220)

The control application 220 of the embodiment includes at least a program for executing calibration processing for calibrating the radio wave intensity of signals transmitted and received between the mobile body 10 and the portable device 20 on the basis of the calibration information stored in the portable device 20.

Further, the control application 220 of the embodiment may have a function of calculating and storing the above-described calibration information.

The details of the functions of the control application 220 of the embodiment will be described later.

The above has described the functional configuration example of the control system 10 of the embodiment. Note that the functional configuration described above with reference to FIG. 1 is merely an example, and the functional configuration of the control system 1 of the embodiment is not limited thereto.

The functional configuration of the control system 1 of the embodiment can be modified flexibly depending on specifications, uses, or the like.

### <<1.2. Calculation and Storage of Calibration Information>>

As described above, there has been developed the technology in which a mobile body estimates a distance to a portable device on the basis of the received radio wave intensity of a signal received from the portable device, and controls the operation of a controlled device on the basis of the estimation result.

However, the output radio wave intensity of portable devices normally differs depending on the model and the like.

Thus, even if a portable device of model X and a portable device of model Y are at the same distance from a mobile body, the RSSI of the signal received by the mobile body from the portable device of model X may be different from the RSSI of the signal received by the mobile body from the portable device of model Y.

Further, due to the above-described difference, there may be occurred a situation in which a portable device of a certain model is estimated to be outside a predetermined range from a mobile body even though the portable device is located within the predetermined range, or a situation in which a portable device of a certain model is estimated to be within a predetermined range from a mobile body even though the portable device is located outside the predetermined range.

In order to prevent the above-described situations, it is assumed that the estimation accuracy is improved by leveling the received radio wave intensity of a signal received from a portable device on the basis of calibration information, as disclosed in Japanese Patent Application Laid-open No. 2019-32169, for example.

However, in the case of calculation and storage of calibration information by the ECU, the increase in the number of portable devices (users) results in the increase of calibration information, which oppresses a memory of the ECU.

In addition, in recent years, a large number of users may share a mobile body in car sharing or the like, and there is a possibility that the number of users needs to be restricted due to the memory constraints of the ECU.

The technical ideas of the present invention have been made in view of the above-described aspect, and improve the estimation accuracy while reducing the ECU memory usage.

In order to realize the above, one of the features of the control system 1 of the present embodiment is that the control application 220 installed in the portable device 20 is responsible for the calculation and storage of calibration information.

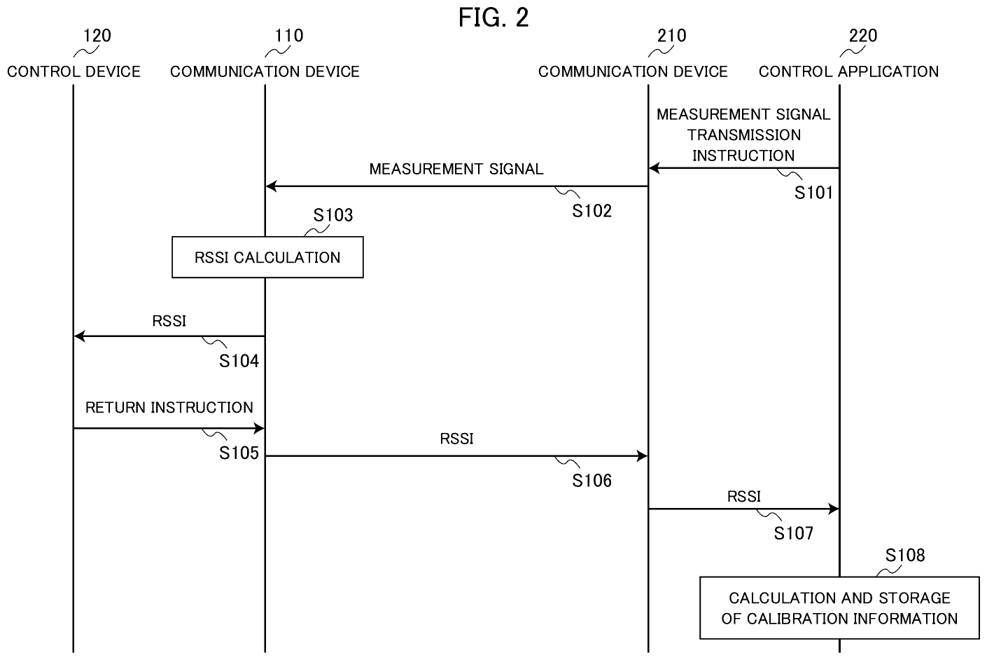

FIG. 2 is a sequence diagram illustrating an example of a flow of calculation and storage of calibration information by the control system 1 according to the embodiment.

In a case of the example illustrated in FIG. 2, the control application 220 provided in the portable device 20 first outputs a measurement signal (a signal subjected to RSSI calculation) transmission instruction to the communication device 210 on the basis of an operation by a user or the like (S101).

The communication device 210 transmits a measurement signal on the basis of the measurement signal transmission instruction input at Step S101 (Step S102).

The communication device 110 having received the measurement signal at Step S102 calculates an RSSI of the measurement signal (S103).

The communication device 110 transmits the RSSI of the measurement signal calculated at Step S103 to the control device 120 (Step S104).

Next, the control device 120 outputs a return instruction to the communication device 110 to return the RSSI calculated at Step S103 to the communication device 210 (S105).

The communication device 110 transmits the RSSI calculated at Step S103 to the communication device 210 on the basis of the return instruction input at Step S105 (S106).

The communication device 210 having received the RSSI at Step S106 relays the RSSI to the control application (S107).

Next, the control application 220 calculates calibration information in accordance with the portable device 20 on the basis of the RSSI input at Step S107, and stores the calibration information (S108).

The control application 220 may calculate calibration information by comparing the RSSI input at Step S107 with a preliminarily stored reference value, for example.

The above-described reference value may be, for example, an average value of the RSSIs of signals received from the portable devices 20 of a plurality of models at the same distance.

For example, the control application 220 may obtain a variable having the RSSI input at Step S107 equivalent to a reference value, and store the variable as calibration information.

The above has described an example of the flow of calculation and storage of calibration information according to the embodiment.

As described above, in a case where the portable device 20 calculates and stores calibration information, it is possible to effectively reduce a memory of the ECU provided in the mobile body 10.

Note that the flow of calculation and storage of calibration information described with reference to FIG. 2 is merely an example, and it is possible to flexibly modify the flow of calculation and storage of calibration information by the control system 1 according to the embodiment.

For example, FIG. 2 illustrates a case where the communication device 110 calculates an RSSI, but the control device 120 may calculate an RSSI.

### <<1.3. Calibration Processing>>

The following will describe a flow of calibration processing according to the embodiment with reference to a concrete example.

The following will first describe a flow in a case where the control application 220 installed in the portable device 20 performs calibration processing on the basis of calibration information.

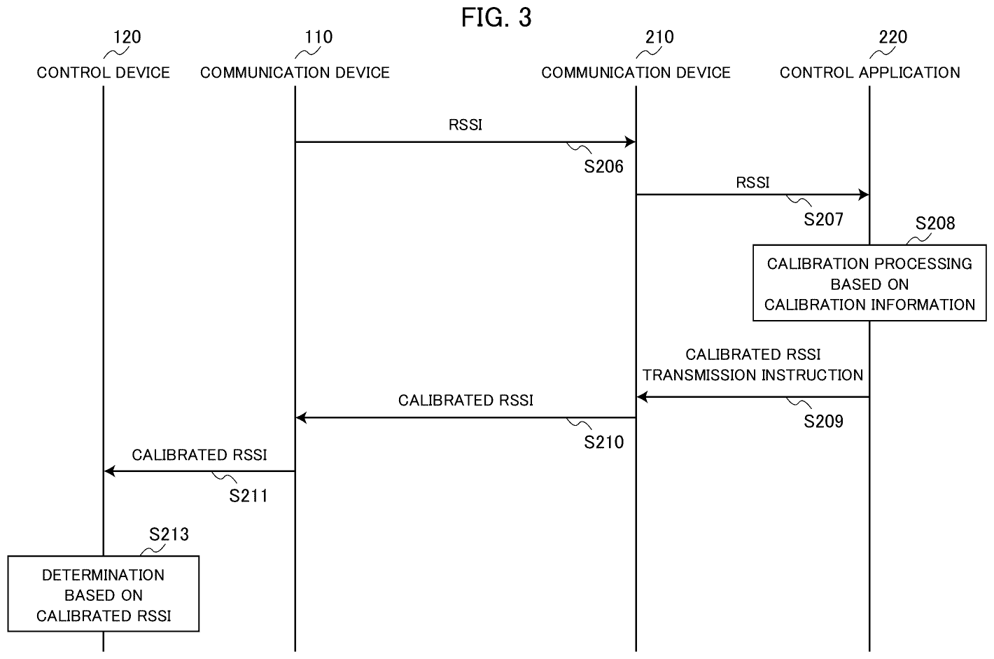

FIG. 3 is a sequence diagram illustrating an example of a flow of RSSI calibration by the control application 220 according to the embodiment.

First, the control system 1 performs Steps S201 to S205, which are the processing equivalent to Steps S101 to S105 illustrated in FIG. 2 (the illustration is omitted in FIG. 3).

Next, the communication device 110 transmits the RSSI calculated at Step S203 to the communication device 210 (Step S206).

The communication device 210 having received the RSSI at Step S206 relays the RSSI to the control application 220 (S207).

The control application 220 performs calibration processing for calibrating the RSSI input at Step S207 on the basis of the calibration information calculated and stored at Step S108 of FIG. 2 (S208).

Next, the control application 220 outputs an instruction to the communication device 210 to transmit the calibrated RSSI obtained by the calibration processing at Step S208 (S209).

The communication device 210 transmits the calibrated RSSI to the communication device 110 on the basis of the transmission instruction input at Step S209 (S210).

The communication device 110 relays the calibrated RSSI received at Step S210 to the control device 120 (Step S211).

The control device 120 determines whether or not to cause the controlled device 130 to perform a prescribed operation on the basis of the calibrated RSSI input at Step S211, that is, the radio wave intensity subjected to the calibration processing (S212).

As described above, the control application 220 of the embodiment may calibrate, on the basis of the calibration information, the received radio wave intensity of the signal received by the mobile body 10 from the portable device 20, the received radio wave intensity being received from the mobile body 10, and perform a control of transmitting the calibrated received radio wave intensity to the mobile body 10.

In the series of processing described above, it is possible to improve the estimation accuracy while reducing the ECU memory usage.

The following will describe a flow in a case where the control device 120 of the embodiment performs calibration processing on the basis of calibration information.

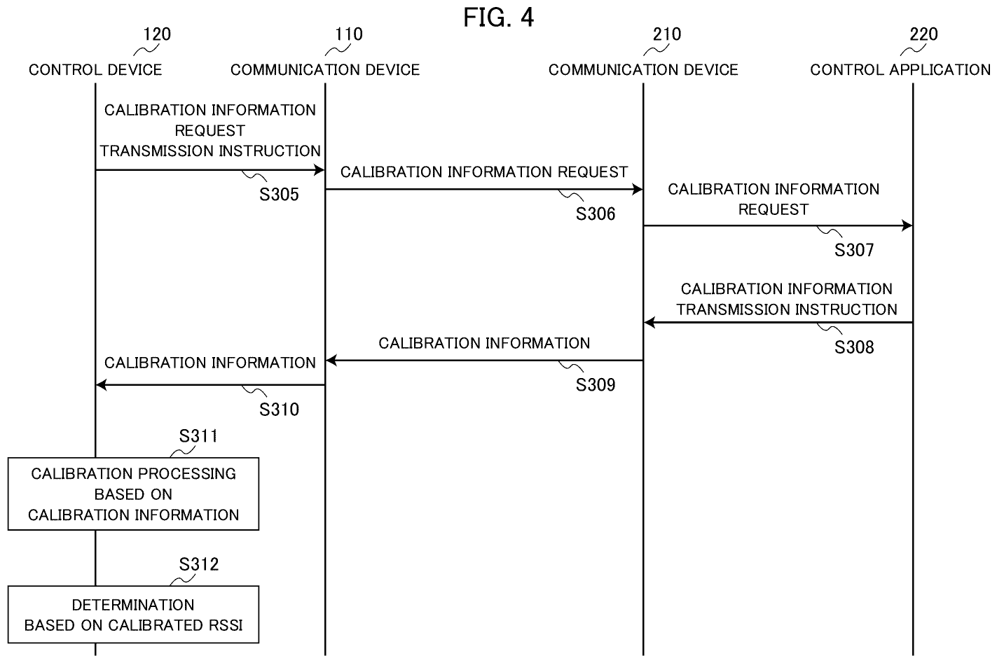

FIG. 4 is a sequence diagram illustrating an example of a flow of RSSI calibration by the control device 120 according to the embodiment.

First, the control system 1 performs Steps S301 to S304, which are the processing equivalent to Steps S101 to S104 illustrated in FIG. 2 (the illustration is omitted in FIG. 4).

Next, the control device 120 outputs a calibration information request transmission instruction, which is a signal requesting the transmission of calibration information, to the communication device 110 (S305).

The communication device 110 transmits the calibration information request to the communication device 210 on the basis of the transmission instruction input at Step S305 (S306).

The communication device 210 having received the calibration information request at Step S306 relays the calibration information request to the control application 220 (S307).

The control application 220 outputs the calibration information transmission instruction calculated and stored at Step S108 illustrated in FIG. 2 to the communication device 210 on the basis of the calibration information request input at Step S307 (S308).

The communication device 210 transmits the calibration information to the communication device 110 on the basis of the transmission instruction input at Step S308 (S309).

The communication device 110 relays the calibration information received at Step S309 to the control device 120 (Step S310).

The control device 120 performs calibration processing for calibrating the RSSI input at Step S304 on the basis of the calibration information input at Step S310 (S311).

Next, the control device 120 determines whether or not to cause the controlled device 130 to perform a prescribed operation on the basis of the calibrated RSSI obtained at Step S311 (S312).

As described above, the control device 120 of the embodiment may calibrate the received radio wave intensity of the signal received from the portable device 20 on the basis of the calibration information received from the portable device 10.

In this case, the control device 120 only needs to temporarily retain the calibration information without the necessity of storing the calibration information for a long time, and thus it is possible to reduce the amount of memory usage.

Note that FIG. 4 illustrates a case where the portable device 20 transmits calibration information to the mobile body 10 on the basis of the calibration information request received from the mobile body 10, but the flow of transmission and reception of calibration information is not limited to such an example.

For example, the calibration information of the embodiment may be included in a measurement signal.

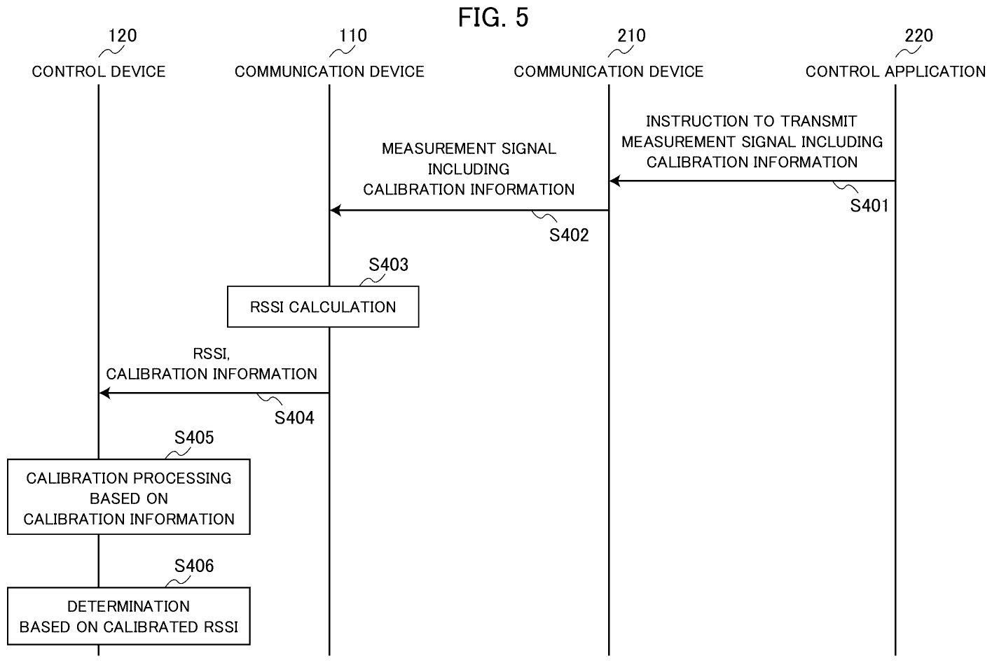

FIG. 5 is a sequence diagram illustrating a flow of calibration processing based on calibration information included in a measurement signal according to the embodiment.

In the case of an example illustrated in FIG. 5, the control application 220 first outputs an instruction to the communication device 210 to transmit a measurement signal including the calibration information calculated and stored at Step S108 illustrated in FIG. 2 (S401).

The communication device 210 transmits a measurement signal including the calibration information to the communication device 110 on the basis of the transmission instruction input at Step S401 (S402).

The communication device 110 calculates an RSSI of the measurement signal including the calibration information received at Step 402 (S403).

Next, the communication device 110 outputs the RSSI calculated at Step S403 and the calibration information extracted from the measurement signal to the control device 120 (S404).

The control device 120 performs calibration processing for calibrating the RSSI input at Step S404 on the basis of the calibration information input at Step S404 (S405).

Next, the control device 120 determines whether or not to cause the controlled device 130 to perform a prescribed operation on the basis of the calibrated RSSI obtained at Step S405 (S406).

As described above, the control device 120 of the embodiment may calibrate the received radio wave intensity of the signal received from the portable device 20 on the basis of the calibration information included in the signal.

With this, it is possible to simplify communication and increase processing efficiency.

The above has described the case where the calibration processing of the embodiment is processing for calibrating the received radio wave intensity of the signal received from the portable device 20 on the basis of the calibration information.

Meanwhile, the calibration processing of the embodiment may be processing for controlling the output radio wave intensity of a signal transmitted by the portable device 20 on the basis of the calibration information.

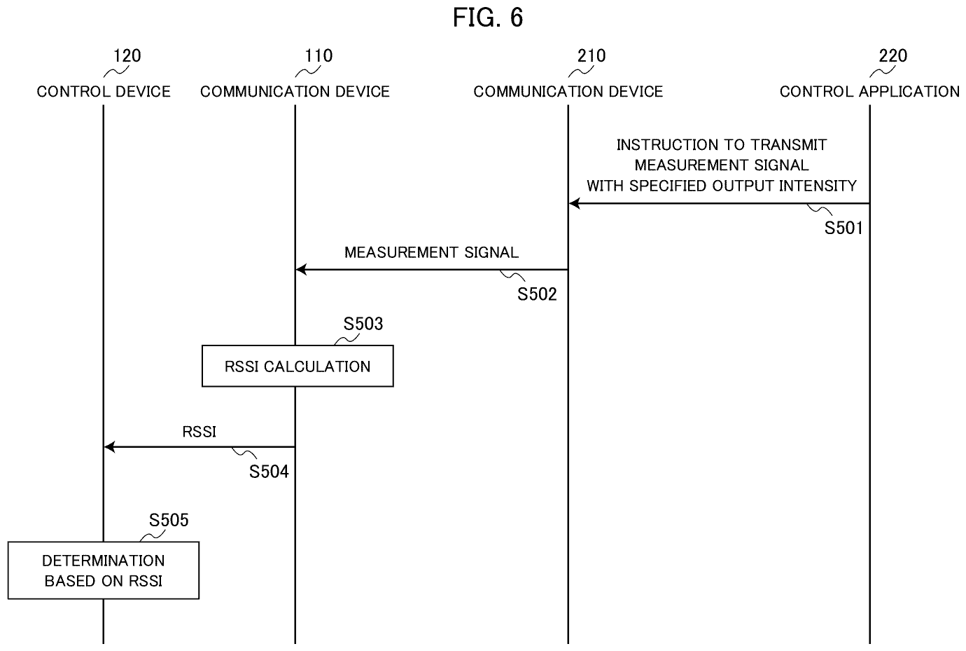

FIG. 6 is a sequence diagram illustrating a flow of calibration processing for controlling the output radio wave intensity of a signal on the basis of calibration information according to the embodiment.

In the case of an example illustrated in FIG. 6, the control application 220 first outputs an instruction to the communication device 210 to transmit a measurement signal with specified output intensity on the basis of the calibration information calculated and stored at Step S108 illustrated in FIG. 2 (S501).

The communication device 210 transmits a measurement signal at the specified output intensity to the communication device 110 on the basis of the transmission instruction input at Step S501 (S502).

The communication device 110 calculates an RSSI of the measurement signal received at Step 502 (S503).

Next, the communication device 110 outputs the RSSI calculated at Step S503 to the control device 120 (Step S504).

The control device 120 determines whether or not to cause the controlled device 130 to perform a prescribed operation on the basis of the RSSI input at Step S504 (S505).

The above has described a flow of calibration processing for controlling the output radio wave intensity of a signal on the basis of the calibration information according to the embodiment.

In the above-described calibration processing, it is possible to improve the estimation accuracy while reducing the ECU memory usage.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, in the above-described embodiment, the calibration information is stored in the portable device 20. However, the calibration information may be stored in a server, for example. In this case, the control application 220 or the control device 120 is able to perform calibration processing by acquiring calibration information from the server.

Further, in the above-described embodiment, the model of the portable device 20 is exemplified as a major factor that causes a difference in output intensity of a signal transmitted by the portable device 20. However, the difference in output intensity of a signal may be caused by a cover or case attached to the portable device 20 or by the deterioration of a battery of the portable device 20.

Therefore, when the cover, case, or the like is replaced, or when there is concern about battery deterioration, the user may instruct the control application 220 to recalculate calibration information. Further, in a case where it is possible to automatically detect the replacement of the cover, case, or the like, or the deterioration of the battery, the control application 220 may automatically recalculate calibration information.

Moreover, a sequence of processing by the devices described in the present specification may be achieved by a program stored in a non-transitory computer readable storage medium. Each program is read in a random access memory (RAM) when executed by a computer, and executed by a processor such as a central processing unit (CPU). The above-described storage medium is, for example, a magnetic disk, an optical disk, a magneto-optical disk, a flash memory, or the like. Moreover, the above-described program may be distributed through a network, for example, without using any storage medium.

What is claimed is:

1. A control device, comprising:
a control unit that performs calibration processing for calibrating a radio wave intensity of a signal transmitted and received between a control target and a portable device on the basis of calibration information stored in the portable device, wherein
whether or not to cause a controlled device provided in the control target to perform a prescribed operation is determined on the basis of the calibrated radio wave intensity.

2. The control device according to claim 1, wherein as the calibration processing, the control unit calibrates a received radio wave intensity of a signal received from the portable device on the basis of the calibration information.

3. The control device according to claim 2, wherein
the control device is provided in the portable device, and
the control unit calibrates, on the basis of the calibration information, a received radio wave intensity of a signal received by the control target from the portable device, the received radio wave intensity being received from the control target, and transmits the calibrated radio wave intensity to the control target.

4. The control device according to claim 2, wherein
the control device is provided in the control target, and
the control unit calibrates a received radio wave intensity of a signal received from the portable device on the basis of the calibration information received from the portable device.

5. The control device according to claim 4, wherein the control unit calibrates a received radio wave intensity of a signal received from the portable device on the basis of the calibration information included in the signal.

6. The control device according to claim 1, wherein
the control device is provided in the portable device, and
as the calibration processing, the control unit calibrates an output radio wave intensity of a signal transmitted by the portable device on the basis of the calibration information.

7. The control device according to claim 1, wherein the control unit calculates the calibration information on the basis of comparison between a received radio wave intensity of a signal received by the control target from the portable device and a preliminarily stored reference value.

8. The control device according to claim 1, wherein the prescribed operation includes locking or unlocking of a door provided in the control target.

9. A non-transitory computer readable storage medium storing a program, the program causing a computer to achieve:
a control function of performing calibration processing for calibrating a radio wave intensity of a signal transmitted and received between a control target and a portable device on the basis of calibration information stored in the portable device, wherein
whether or not to cause a controlled device provided in the control target to perform a prescribed operation is determined on the basis of the calibrated radio wave intensity.

10. A control system, comprising:
a program causing a computer to achieve a control function of performing calibration processing for calibrating a radio wave intensity of a signal transmitted and received between a control target and a portable device on the basis of calibration information stored in the portable device; and
a determination device that determines whether or not to cause a controlled device provided in the control target to perform a prescribed operation on the basis of the calibrated radio wave intensity.
